(19) United States
(12) Patent Application Publication
(10) Pub. No.: US 2008/0231548 A1
(43) Pub. Date: Sep. 25, 2008

(54) 3D Display Device and 3D Display Method

(75) Inventor: Tamami Koyama, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 12/063,806

(22) PCT Filed: Aug. 23, 2006
(86) PCT No.: PCT/JP2006/317029

§ 371 Date: Feb. 14, 2008

(30) Foreign Application Priority Data
Aug. 31, 2005 (JP) 2005-251964

(51) Int. Cl. G09G 5/00

(52) U.S. Cl. 345/6

(57) ABSTRACT

A 3D display device, including a plurality of display means located in tandem on the same line of sight of an observer at a given distance; a control means which controls the plurality of display means to display an image obtained from the same object on almost the same screen position in each of the plurality of display means by mutually changing the brightness so that a 3D image may be displayed from the sight of the observer; wherein all the display means or at least one display means except for the display means located at the backmost position from the sight of the observer comprise a device for displaying having an image displaying surface which is self-luminescent and has light transmittance, and the device for displaying comprises an organic EL element provided with an organic EL layer containing a phosphorescent compound.

### CROSS REFERENCES OF RELATED APPLICATIONS

This application is an application filed under 35 U.S.C. §111(a) claiming benefit pursuant to 35 U.S.C. §119(e) (1) of the filing dates of Provisional Application 60/714,868 filed Sep. 8, 2005 pursuant to 35 U.S.C. §111(b).

### TECHNICAL FIELD

The present invention relates to a brightness modulation type 3D display device in which an observer can see a 3D image wherein a plurality of images is displayed by superposition with changing the brightness of the images and 3D display method.

### BACKGROUND ART

Conventionally, a liquid crystal shutter glasses system and the like are well known as the device which is electrically rewritable and enables 3D display of a moving image. In the liquid crystal shutter glasses system, a 3D object is shot with a camera in different directions, image data including obtained parallax information are synthesized into an image signal, and the image is inputted into a two-dimensional display device and displayed. The observer wears a liquid crystal shutter glasses, and, for example, the liquid crystal shutter for the right eye is set to a light transmitting state at the time of odd field timing, and the liquid crystal shutter for the left eye is set to a light blocking state. On the other hand, the liquid crystal shutter for the left eye is set to a light transmitting state at the time of even field timing, and the liquid crystal shutter for the right eye is made to a light blocking state. At this time, a 3D image can be obtained by visually watching the images including parallax for the right eye and the left eye with the respective eyes by displaying by synchronizing an image for the right eye to the odd field and an image for the left eye to the even field.

In the liquid crystal shutter glasses system, the use of the liquid-crystal shutter glasses is required, and gives a sense of discomfort to a user in the case of, for example, video conference. Furthermore, a large contradiction between binocular parallax or convergence and focus adjustment may occur among the physiological factors of stereoscopic vision. That is, although the liquid crystal shutter glasses system roughly satisfies the binocular parallax and convergence, the contradiction may cause eye fatigue and the like because the focal plane is on the surface.

Therefore, conventionally, in order to solve the above-mentioned contradiction between the binocular parallax or convergence and the focal adjustment, a volume visualization system has been proposed which displays a 3D object by displaying a plurality of sheets of two-dimensional display device in front of the observer. According to this system, a bunch of two-dimensional images sampled in the depth direction from the observer is displayed, for example, on the two two-dimensional display devices located at a given distance, and then a 3D image is formed between the two two-dimensional display devices. For this reason, unlike the liquid crystal shutter glasses display device, the contradiction between the binocular parallax or convergence and the focus adjustment is considered to be contained. However, since the 3D image is discrete in the depth direction according to the volume visualization system, it is difficult to reproduce the object which is in the intermediate position or largely varied in the depth direction.

Therefore, conventionally, the brightness modulation type display system has been proposed which can complement the discrete location by changing brightness of the image displayed on each of the two two-dimensional display devices. According to the system, the contradiction between the binocular parallax or convergence and the focus adjustment can be contained and the eye fatigue and the like can be reduced. Moreover, there is considered to be an advantage for largely reducing the data volume in performing the 3D display because an object at the intermediate position on the image surface is also stereoscopically or three-dimensionally observed by the observer and additionally an object at a plurality of surfaces may also be represented.

However, in such a brightness modulation type display system, there exists a problem that it is not possible to display a translucent object through which an object at the back is seen or it is not possible to display an object in a way as if an object at the back is seen through.

On the contrary, a brightness modulation type 3D display system is proposed, wherein it is possible to display a translucent object or an object in a way as if an object at the back is seen through by superposing and displaying the object images from the plurality of display devices using a plurality of half mirrors, for example, JP-A-2000-115812.

However, since this system comprises a plurality of optical components such as a plurality of half mirrors and the like, the configuration of the device is relatively large and complicated, making it difficult to respond to general requirements for miniaturization, weight reduction or low cost of the device in the technical field.

In contrast, the brightness modulation type 3D display device and method thereof, which has a small-size and simple configuration and can perform advanced 3D display, is disclosed in JP-A-2004-29750 (Patent Document 1). As a display means, for example, it is also described that an organic EL display device (In the description, “electro-luminescence” is also referred to as “EL”) may be used. However, such a 3D display device and method thereof have a problem that the 3D images displayed are not sufficiently clear.

Patent document 1; JP-A-2004-29750

### DISCLOSURE OF THE INVENTION

The present invention is made in light of conventional technical problems described above. An object of the present invention is to provide a brightness modulation type 3D display device and method thereof which can clearly perform 3D display of images.

The inventors have completed the present invention after studying earnestly for solving the problems. The present invention relates to the following [1] to [24].

[1]

A 3D display device, comprising:

a plurality of display means located in tandem on the same line of sight of an observer at a given distance;

a control means which controls the plurality of display means to display an image obtained from the same object on almost the same screen position in each of the plurality of display means by mutually changing the brightness so that a 3D image may be displayed from the sight of the observer;

wherein all the display means or at least one display means except for the display means located at the backmost position from the sight of the observer comprise a device for displaying having an image displaying surface which is self-luminescent and has light transmittance, and

the device for displaying comprises an organic electro-luminescence element (hereinafter, also referred to as organic EL element) provided with an organic electro-luminescence layer (hereinafter, also referred to as organic EL layer) containing a phosphorescent compound.

[2]

The 3D display device according to [1], wherein the control means controls

the plurality of display means so that a display means located at the front among the plurality of display means displays the object image at a higher brightness than does a display means located at the back when an object displayed as the object image is displayed so that the object is positioned closer to the sight of the observer, and, the plurality of display means so that a display means located at the back among the plurality of display means displays the object image at a higher brightness than does a display means located at the front when the object is displayed so that the object is positioned farther away from the sight of the observer.

[3]

The 3D display device according to [2], wherein the control means further controls the plurality of display means so that the brightness synthesized from the display means at the front and the display means at the back may be a given value.

[4]

The 3D display device according to [2] or [3] wherein the control means controls the brightness based on the distance from a shooting means when the object is shot to the object.

[5]

The 3D display device according to any one of [2] to [4], wherein an input means is further provided which can set the brightness to a desired value.

[6]

The 3D display device according to any one of [1] to [5], wherein a display means comprising the device for displaying which emits self-luminescence so that the amount of emission toward the observer is larger than that away from the observer.

[7]

The 3D display device according to any one of [1] to [6], wherein a half mirror is further provided on the rear surface of a display means comprising the device for displaying.

[8]

The 3D display device according to any one of [1] to [7], wherein a filter in which the amount of transmitted light in the direction away from the observer is smaller than that in the direction toward the observer is further provided on the rear surface of the display means comprising the device for displaying.

[9]

The 3D display device according to any one of [1] to [8], wherein a polarizing plate is further provided on the rear surface of the display means comprising the device for displaying.

[10]

The 3D display device according to any one of [1] to [9], wherein an antireflection treatment is applied to the surface of the display means located at the back among the plurality of display means.

[11]

The 3D display device according to any one of [1] to [10], wherein an antireflection film is provided on the surface of the display means located at the back among the plurality of display means.

[12]

The 3D display device according to any one of [1] to [11], wherein a light scattering plate is provided on the surface of the display means located at the back among the plurality of display means.

[13]

The 3D display device according to any one of [1] to [12], wherein, unlike the device for displaying, the backmost display means comprises other device for displaying having an image display surface without light transmittance.

[14]

The 3D display device according to any one of [1] to [13], wherein the phosphorescent compound is a phosphorescent high-molecular compound.

[15]

A 3D display method using a 3D display device comprised of a plurality of display means located in tandem on the same line of sight of the observer at a given distance, wherein all the display means or at least one display means except for the display means located at the backmost position from the sight of the observer comprise a device for displaying which has an image display surface that is self-luminescent and has light transmittance, comprising;

a control step of controlling the plurality of display means to display an image obtained from the same object on almost the same screen position in each of the plurality of display means by changing the brightness so that a 3D image may be displayed from the sight of the observer;

wherein the device for displaying comprises an organic EL element provided with an organic EL layer containing a phosphorescent compound.

[16]

The 3D display method according to [15], wherein the control step comprises:

a step of controlling the plurality of display means so that a display means located at the front among the plurality of display means displays the object image at a higher brightness than does a display means located at the back when an object displayed as the object image is displayed so that the object may be positioned closer to the sight of the observer, and

a step of controlling the plurality of display means so that a display means located at the back among the plurality of display means displays the object image at a higher brightness than does a display means located at the front when the object is displayed so that the object may be positioned farther away from the sight of the observer.

[17]

The 3D display method according to [16], wherein the control step further comprises a step of controlling the plurality of display means so that the brightness synthesized from the display means at the front and the display means at the back may be a given value.

[18]

The 3D display method according to any one of [15] to [17], wherein the control step comprises a step of controlling the brightness based on the distance from a shooting means when the object is shot to the object.

[19]

The 3D display method according to any one of [15] to [18], wherein the phosphorescent compound is a phosphorescent high-molecular compound.

[20]

A display device equipped with the 3D display device of any one of [1] to [14].

[21]

A display device according to [20], wherein the display device is a display for computer, a display for television, a display for a portable terminal device, a display for a cellular phone, a car navigation display or a view finder of video camera.

[22]

An illumination device equipped with the 3D display device of any one of [1] to [14].

[23]

An interior equipped with the 3D display device of any one of [1] to [14].

[24]

An exterior equipped with the 3D display device of any one of [1] to [14].

According to the 3D display device of the present invention, a plurality of each display means is located on the same line of sight of the observer at a given distance. As the display means, a device is used which displays an image by self-luminescence of the image to be displayed and transmits the light from the back at least during non-luminescence. Under the control by the control means, when an image obtained from the same object (for example, the same object image, images with different sizes obtained from the same object, or the like) is displayed to each of the display means by mutually changing the brightness on almost the same screen position, the observer can see the image displayed by the display means located at the front superposed, by transmittance through the display means, with the image displayed by the display means located at the back. That is, the observer positioned on the line of sight can see a brightness modulation type 3D image.

In the present invention, all of the plurality of display means located in this way or at least one display means except for the display means located at the backmost position are configured by using a device for displaying with an image display surface which is self-luminescent and has light transmittance. And as the device for displaying, a display device is used which comprises an organic EL element with an organic EL layer containing a phosphorescent compound (hereinafter, referred to as “a phosphorescent organic EL display device”).

On the other hand, the display means at the backmost position is not required to have light transmittance because no images coming from the back exist. For this means, there may be used not only the phosphorescent organic EL display device, but also, for example, a liquid crystal display device, a plasma display device, a cathode-ray tube display device, a display device comprising an organic EL element with an organic EL layer containing a fluorescent compound and the like.

In the present invention, a minimum of two display means is sufficient as a plurality of display means. In this case, the 3D position of the image to be displayed is between the two display means and is obtained as the position correlated by the brightness. In addition, for example, the display means may be configured so as to provide three display means each corresponding to a color of RGB signal. Furthermore, while receiving and displaying images which are being broadcasted, the display means may be configured to display images by superposing 3D images on the images.

As described above, according to the 3D display device of the present invention, by using a device for displaying which is self-luminescent and has light transmittance as a display means, an optical element such as a plurality of half mirrors and the like for superposing or synthesizing a plurality of object images, for example, as described in the above-mentioned JP-A-2000-115812, is not necessary, thereby making it possible to realize a brightness modulation type 3D display device which is small-sized and easy to adjust.

And, because all the plurality of display means or at least one display means except for the display means located at the backmost position are the phosphorescent organic EL display device, the 3D display device of the present invention has high light transmittance at the time of nondisplay (at the time of non-luminescence) compared to the 3D display device disclosed in the above-mentioned Patent Document 1 and the like [a 3D display device using an organic EL display device in which the hole injection layer is formed, for example, by CuPc (copper phthalocyanine), the hole-transporting layer by NPB (N,N-di(naphthalen-1-yl)-N,N-diphenylbenzidene), the light-emitting layer by Alq₃ (tris-(8-hydroxyquinoline)aluminum), the electron-transporting layer by BCP (bathocuproine), and the electron injection layer by LiF (lithium fluoride), respectively]. Thus, the 3D display device of the present invention is advantageous in observing the transmission of the luminescent image from the display means at the back. For this reason, the 3D display device of the present invention can display 3D images more clearly than conventionally.

Moreover, since the luminous efficiency of the phosphorescent compound is high compared to that of the fluorescent compound, the self-luminescence from the phosphorescent organic EL display device has high brightness. For this reason, the 3D display device of the present invention can display 3D images more clearly than conventionally.

According to the above aspect [2], the control means controls the brightness of an image displayed on the individual display means in order for the observer to see the object image as a 3D image. For example, in order for the observer to perceives visually at the closer position, the brightness of the display means at the front is increased and the brightness of the display means at the back is reduced. Then, the observer visually perceives the image as though it is closer to the display means at the front. On the other hand, in order to make the observer perceives visually at the farther position, the brightness of the display means at the front is reduced and the brightness of the display means at the back is increased. Then, the observer visually perceives the image as though it is closer to the display means at the back. Therefore, the observer on the line of sight can see the brightness modulation type 3D image.

According to the above aspect [3], in either case, the brightness synthesized from the brightness of all the display means is controlled so as to be a given value (for example, a fixed value), thereby making it possible to effectively prevent the occurrence of blinks or flickers on the screen which is accompanied by the variation of the brightness.

According to the above aspect [4], the brightness of the image displayed by the 3D display device of the present invention is controlled based on the distance from the shooting device to the object. As the information of the distance at the time, the distance to individual objects is measured by a distance measuring means when the objects are shot and recorded in relation to the image information. If the object is closer to the shooting device, it is displayed by increasing the brightness of the display means at the front to be higher than that of the display means at the back. On the contrary, if the object is farther away from the shooting device, it is displayed by increasing the brightness of the display means at the front to be lower than that of the display means at the back. In this way, the distance relationship when a real object is shot can be reproduced. For the measurement of the distance, a method using ultrasonic wave, infrared light and the like is employed.

According to the above aspect [5], the observer or a manufacturer can set the brightness through an input means to a desired value, thereby making it possible to see the object by freely setting the positional relationship of the object. It is of importance to specify the positional relationship of the object especially for the image created by a computer. The input means includes, for example, a method in which the positional relationship is specified in the program of a computer or a method in which the positional relationship is specified from an input device such as keyboard, etc. while watching the image.

According to the above aspect [6], in the display means comprising the device for displaying, that is, located at the front or not at the backmost position, the amount of emission in the direction away from the observer is small. Therefore it makes possible to reduce the amount of light which goes in the direction away from the observer, is reflected on the surface of the display means disposed at the back and, thereby, causes image noise toward the observer. Thus, the quality of the 3D image watched by the observer is improved.

According to the above aspect [7], in the display means comprising the device for displaying, that is, located at the front or not at the backmost position, the light in the direction away from the observer can be reduced or blocked by a half mirror. Thus, it makes possible to reduce the amount of light which goes in the direction away from the observer, is reflected on the surface of the display means disposed at the back and, thereby, causes image noise toward the observer.

Furthermore, such a half mirror is preferably located perpendicularly to the line of sight so as to be superposed to the device for displaying or located oppositely to the device for displaying adjacently or at a given distance, thereby making it possible to prevent the enlargement of optical system by the half mirror.

According to the above aspect [8], in the display means comprising the device for displaying, that is, located at the front or not at the backmost position, the light in the direction away from the observer can be reduced or blocked by a filter. Thus, it makes possible to reduce the amount of light which goes in the direction away from the observer, is reflected on the surface of the display means disposed at the back and, thereby, causes image noise toward the observer.

According to the above aspect [9], in the display means comprising the device for displaying, that is, located at the front or not at the backmost position, the light away from the observer can be reduced or blocked by a polarizing plate. Thus, it makes possible to reduce the amount of light which goes in the direction away from the observer, is reflected on the surface of the display means disposed at the back and, thereby, causes image noise toward the observer. Especially if the polarizing plate is provided so that the light directed to the object image of the display means at the back is transmitted, bright 3D display can be performed.

According to the above aspect [10], by applying the antireflection treatment, reflection of the light directing to the back from the display means located at the front on the surface of the display means located at the back or at the backmost position is effectively prevented. As a result, the image noise caused by the reflection light and directing to the observer can be reduced.

According to the above aspect [11], by providing the antireflection film, reflection of the light directing to the back from the display means located at the front on the surface of the display means located at the back or at the backmost position is effectively prevented. As a result, the image noise caused by the reflection light and directing to the observer can be reduced.

According to the above aspect [12], the light directing to the back from the display means located at the front is scattered by the light scattering plate before reaching to the surface of the display means located at the back or at the backmost position. For this reason, reflection of the light directing to the back on the surface of the display means located at the back or at the backmost position is effectively prevented by the light scattering plate. As a result, the image noise caused by the reflection light and directing to the observer can be reduced.

Moreover, further improvement in, the quality of the 3D image may be obtained by arbitrarily combining measures against the display measures at the front and measures against the display means at the back in the above-described various aspects.

According to the above aspect [13], as to the display means at the backmost position which may not be required to have light transmittance, a device including, for example, a liquid crystal display device, a plasma display device, a cathode-ray tube display device and the like, may be applied which can perform high quality display at relatively inexpensive cost. The device as a whole may efficiently improve economy and performance.

However, the display means at the backmost position may also be configured, like other display means, from the EL display device, etc. which is self-luminescent and has light transmittance. Even though the device is configured in this way, as long as the device for displaying which is self-luminescent and has light transmittance is used as the display means other than the display means at the backmost position, various advantages of the above-described present invention can be obtained reasonably.

According to the above aspect [14], since the organic EL element may be readily manufactured by a wet film-forming method such as a spin coating method, a printing method, an ink jet method and the like, the productivity of the 3D display device is consequently excellent.

According to the 3D display method of the present invention, a plurality of display means are located on the same line of sight of the observer at a given distance. As the display means, a device for displaying is, used which displays an image by self-luminescence of the image to be displayed and transmits the light from the back at least at the time of non-luminescence. At this time, with the control process, when an image obtained from the same object is displayed to each of the display means by mutually changing the brightness on the same screen position, the observer can see the image displayed by the display means located at the front superposed, by transmittance through the display means, with the image displayed by the display means located at the back. That is, the observer positioned on the line of sight can see a brightness modulation type 3D image.

In the present invention, all of the plurality of display means located in this way or all the display means except for the display means located at the backmost position are configured by using a phosphorescent organic EL display device having an image display surface which is self-luminescent and has light transmittance. For this reason, the 3D display may be performed by a relatively simple control without requiring use of the optical elements such as a plurality of half mirrors and the like, for example, as described in the above-mentioned JP-A-2000-115812.

And, because all the plurality of display means or at least one display means except for the display means located at the backmost position are the phosphorescent organic EL display device, the 3D display device of the present invention has high light transmittance at the time of nondisplay (at the time of non-luminescence) compared to the 3D display device disclosed in the above-mentioned Patent Document 1 and the like. Thus, the 3D display device of the present invention is advantageous in observing the transmission of the luminescent image from the display means at the back. For this reason, the 3D display device of the present invention can display 3D images more clearly than conventionally.

Moreover, since the luminous efficiency of the phosphorescent compound is high compared to that of the fluorescent compound, the self-luminescence from the phosphorescent organic EL display device is high in brightness. For this reason, the 3D display method of the present invention can display the 3D image more clearly than conventionally.

According to the above aspect [16], the control step controls the brightness of the image displayed on the individual display means in order for the observer to see the object image as a 3D image. For example, in order for the observer to perceive visually at the closer position, the brightness of the display means at the front is increased and the brightness of the display means at the back is reduced. On the other hand, in order to make the observer perceive visually at the farther position, the brightness of the display means at the front is reduced and the brightness of the display means at the back is increased. Therefore, the observer on the line of sight can see the brightness modulation type 3D image.

According to the above aspect [17], in either case, the brightness synthesized from the brightness of all the display means is controlled so as to be a given value (for example, a fixed value), thereby making it possible to effectively prevent the occurrence of blinks or flickers on the screen which is accompanied by the variation of the brightness.

According to the above aspect [18], the brightness of the image displayed by the 3D display device of the present invention is controlled based on the distance from the shooting device to the object. As the information of the distance at the time, the distance to the individual objects is measured by a distance measuring means when the objects are shot and recorded in relation to the image information. If the object is closer to the shooting device, it is displayed, by increasing the brightness of the display means at the front to be higher than that of the display means at the back. On the contrary, if the object is farther away from the shooting device, it is displayed by increasing the brightness of the display means at the front to be lower than that of the display means at the back. In this way, the distance relationship when a real object is shot can be reproduced.

According to the above aspect [19], since the organic EL element may be readily manufactured by a wet film-forming method such as a spin coating method, a printing method, an ink jet method and the like, the 3D display device can be consequently manufactured with excellent productivity.

A display device, an illumination device, an interior and an exteriors of the aspects of the above [20] to [24] are equipped with the 3D display device of the above-described present invention, thereby making it possible to display the 3D image with higher sharpness and brightness than conventionally.

Such mechanisms and benefits of the present invention will become apparent by the embodiments described below.

### EFFECT OF THE INVENTION

As described in detail above, according to the present invention, a brightness modulation type 3D display device and a method thereof, which enable a high quality 3D display can be realized by using a relatively simple configuration and control at a small size or at an inexpensive cost.

Furthermore, since the 3D display device and method thereof of the present invention are equipped with a display means configured from a phosphorescent organic EL display device, light transmittance of the display means at the time of non-luminescence is high, and consequently the luminescent image from the display means at the back can be observed more brightly than conventionally. In addition, because the phosphorescent organic EL display device is excellent in the luminous efficiency, the brightness of self-luminescence is also high. For this reason, according to the 3D display device and method thereof of the present invention, the 3D image can be displayed more clearly than conventionally.

### BRIEF DESCRIPTION OF THE DRAWINGS

FIG. 1 is a conceptual diagram showing a display principle in the embodiment relating to the 3D display device and method of the present invention.

FIG. 2 is another conceptual diagram showing a display principle in the embodiment relating to the 3D display device and method of the present invention.

FIG. 3 is a block diagram showing an outline configuration of the embodiment relating to a shooting device for 3D display of the present invention.

FIG. 4 is a block diagram showing an outline configuration of the embodiment relating to a 3D display device of the present invention.

FIG. 5 is a schematic perspective view of appearance showing the first and second embodiments relating to an image display means of a 3D display device of the present invention.

FIG. 6 is a schematic perspective view of appearance showing the third embodiment relating to an image display means of a 3D display device of the present invention.

FIG. 7 is a schematic perspective view of appearance showing the fourth embodiment relating to an image display means of a 3D display device of the present invention.

FIG. 8 is a schematic perspective view of appearance showing the fifth embodiment relating to an image display means of a 3D display device of the present invention.

FIG. 9 is a schematic perspective view of appearance showing the sixth embodiment relating to an image display means of a 3D display device of the present invention.

FIG. 10 is a schematic cross-sectional view showing a more detailed example of the second embodiment relating to an image display means of a 3D display device of the present invention.

FIG. 11 is a schematic cross-sectional, view showing another more detailed example of the second embodiment relating to an image display means of a 3D display device of the present invention.

FIG. 12 is a schematic cross-sectional view showing another more detailed example of the second embodiment relating to an image display means of a 3D display device of the present invention.

FIG. 13 is a schematic cross-sectional view of an embodiment of an organic EL element used in a 3D display device of the present invention.

1 Shooting device
2 3D display device
10 Observer
11 First display device
12 Second display device
13 Half mirror
14 Optical filter
15 Polarizing plate
16 Antireflection plate
21 First object.
22 Second object
23 Camera
24 Distance meter
25 Recording part
31 Image reproduction part
32 Display image part
33 Distance information part
34 Synchronization signal part
35 Brightness modulation part
36 Signal generation part for the first display device
37 Signal generation part for the second display device
38 Driving part for the first display device
39 Driving part for the second display device
100, 101, 102 Phosphorescent organic EL display device
111 Organic EL light-emitting layer
111a Hole-transporting layer
111b Light-emitting layer
111c Electron-transporting layer
118 Transparent electrode
119 Reflection plate

### BEST MODE FOR CARRYING OUT THE INVENTION

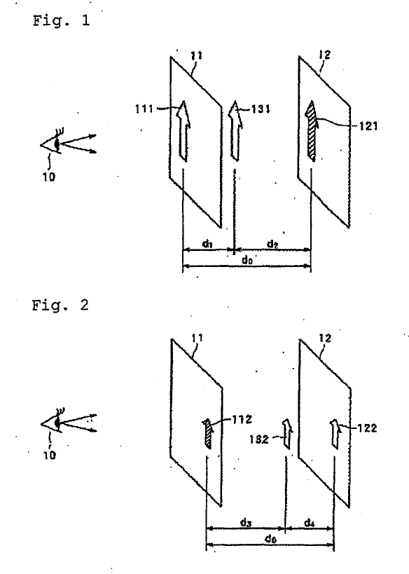

The concept of the 3D display device of the present invention is explained with reference to FIG. 1 and FIG. 2. Here, FIG. 1 shows a state where an object can be seen at the front in the 3D display, and FIG. 2 shows a state where an object can be seen at the back. Moreover, unless otherwise defined, “the surface” of the display device here shall refer to the surface directing in the direction of the observer and “the rear surface” shall refer to the surface directing in the direction opposite to the observer.

As shown in FIG. 1, a display device 11 and a display device 12 are arranged in parallel on the same line of sight of the observer 10 at a given distance d0. In relation to the same object in this state, an image 111 is displayed on the display device 11 and an image 121 on the display device 12. The image 111 and the image 121 are displayed on the position where they are seen by observer 10 as though they are superposed.

In this circumstance, display is made wherein the brightness of the image 111 and that of the image 121 are in a given relationship, and also the brightness synthesized from display device 11 and the display device 12 is constant. It is visually perceived as if a synthesized image 131 is positioned between the display device 11 and the display device 12 when the both images are observed in this state. For example, if the brightness of the image 111 is higher than that of the image 112, it is visually perceived as if the image 131 is positioned at a distance d1 behind the display device 11 and at a distance d2 in front of the display device 12 (d1<d2, d1+d2=d0).

Furthermore, as shown in FIG. 2, in relation to the same other object, the image 112 is displayed on the display device 11 and the image 122 displayed on the display device 12. In this case, if the brightness of the image 112 is lower than that of the image 122, it is visually perceived as if a synthesized image 132 is positioned at a distance d3 behind the display device 11 and at a distance d4 in front of the display device 12 (d3>d4, d3+d4=d0). Display is made such that the brightness synthesized from the display device 11 and the display device 12 is displayed so as to be constant as with the one shown in FIG. 1.

It is visually perceived as if the image 131 is located in front of the image 132 by displaying the images shown in the above-described FIG. 1 and FIG. 2 at a given cycle in which the residual image effect of the observer 10 is obtained. The given cycle is, for example, 1/60 s of field frame cycle in NTSC system, 1/30 s of frame cycle, 1/50 s of field frame cycle in PAL system, or 1/25 s of frame cycle. Alternatively a suitable cycle in which the residual image effect is maintained as a system for a 3D display may be arbitrarily defined.

(A Configuration Example of a Shooting Device of Images for 3D Display)

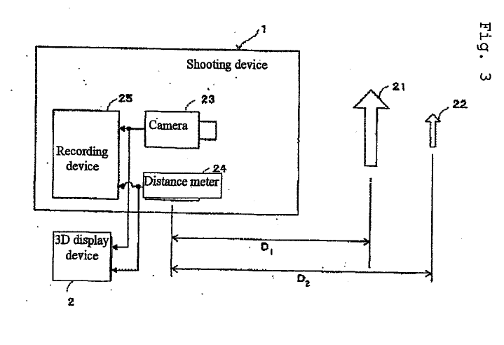

Next, an example of a shooting device 1 for stereoscopically displaying images is explained with reference to FIG. 3. The shooting device 1 comprises, for example, a camera 23, a distance meter 24 and a recording device 25. The camera 23 is a TV camera of a NTSC system, a PAL system and the like. The distance meter 24 measures the distance to an object and uses, for example, infrared light or ultrasonic waves. The recording device 25, which uses tapes, disks and the like as a recording medium, records data on the image data of the object shot by the camera 23 and data on the distance to the object measured by the distance meter 24. As for distance, a given value may be inputted by an input means.

Two objects used for shooting for displaying stereoscopically shall be referred to, for example, a first object 21 and a second object 22. The first object 21 and the second object 22 are located so that they may have the distance difference between the front and back to the observer. The first object 21 and the second object 22 located in this way are shot by the camera 23 from the direction of the observer and the image data are recorded to the recording device 25.

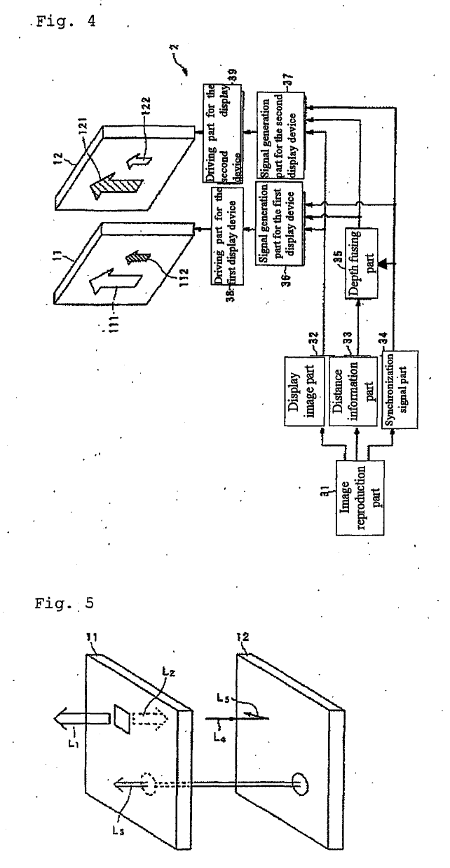

Also, the first object 21 and second object 22 are shot by the camera 23 and simultaneously the distance D1 and D2 to the first object 21 and second object 22, respectively, are measured by the distance meter 24, and the distances are recorded to the recording device 25 by associating with the image data shot by the camera 23. As the reproduction of the 3D image is explained later in detail with reference to FIG. 4, the observer 10 can stereoscopically see the images of the first object 21 and the second object 22 wherein the images of the first object 21 and the second object 22 are displayed in each of a plurality of the display devices by controlling the brightness of the images, based on the distance data relating to the distance D1 and D2.

Furthermore, the 3D image may be displayed by directly entering the image data shot by the camera 23 and the distance data measured by the distance meter 24 to a 3D display device 2. In addition, the image data and distance data are not limited to those obtained by the shooting device 1, and the data created by a computer may also be used.

(A Configuration Example of a 3D Display Device)

Next, with reference to FIG. 4, the 3D display device 2 is explained which displays the image data and distance data obtained by the above-mentioned shooting device 1. The configuration of the 3D display device 2 comprises a first display device 11, a second display device 12, an image reproduction part 31, a display image part 32, a distance information part 33, a synchronization signal part 34, a brightness modulation part 35, a signal generation part for the first display device 36, a signal generation part for the second display device 37, a driving part for the first display device 38 and a driving part for the second display device 39 and the like.

The first display device 11, which is a display device located closer to the observer 10, is configured by using the phosphorescent organic EL display device which is self-luminescent and has light transmittance. Further, the second display device 12 is disposed farther away than the first display device 11 from the observer 10, which, like the first display device 11, is also a device that is self-luminescent and has light transmittance, or a liquid crystal display device, a CRT display device and the like.

The first display device 11 and the second display device 12 are located on the same line of sight of the observer 10 so that the display surfaces of them are vertical to the line of sight. In addition, though not shown in the figure, a plurality of display devices may be additionally inserted between the first display device 11 and the second display device 12. Like the first display device 11, the devices inserted are configured by devices that are self-luminescent and have light transmittance. Also, it is needless to say that a driving means for each display device is required.

The EL display device, which is used as the first display device 11 and a display device disposed between the first display device 11 and the second display device 12 as needed, emit self-luminescence for forming the image and has a characteristic of transmitting light from the back. The use of the display device that emits self-luminescence and transmits light from the back is the major characteristic of the 3D display device of the present invention, contributing to miniaturization and cost reduction of the device. It is needless to say that, the EL display device may also be used to the second display device 12.

The image reproduction part 31 reproduces a medium, for example, a disk recorded with the image data of the first object 21 and the second object 22 shot by the shooting device 1 and the distance data of the first object 21 and the second object 22, and outputs the image data and distance data. Incidentally, when the output of the camera 23 is provided to the 3D display, the image reproduction part 31 is not required.

The display image part 32 configures the image data actually displayed among the information reproduced by the image reproduction part 31. That is, the shot image data of the first object 21 and the second object 22 shown in FIG. 3 are separated and the image information is inputted to the next step for the display process.

The distance information part 33 outputs the distance information, that is, information on the distance of the object shot, for example, the first object 21 and the second object 22 from the camera 23 (more correctly the distance meter 24), to the next step for the display process by separating the information from reproduced signals of the recorded medium. In this case, it is maintained that the distance data and the image data which are simultaneously reproduced are in a synchronized relationship.

The synchronization signal part 34 synchronizes the synchronization signal in displaying the image from reproduction signal of the recorded medium, for example, actually displaying image data of the first object 21 and the second object 22 as well as a signal on horizontal synchronization and vertical synchronization with the distance data on the distance from the camera 23 to conform the distance of the object to a mode which displays the object.

The brightness modulation part 35 controls the brightness of the first object 21 and the second object 22 in displaying on the first display device 11 and the second display device 12, depending on the distance of the first object 21 and the second object 22 that are displayed from the camera 23, that is, the distance from the observer 10. If, for example, the first object 21 is positioned closer to the observer side than the second object 22, the control displays the first object 21 displayed on the first display device 11 with a higher brightness than that of the first object 21 displayed on the second display device 12, while the second object 22 displayed on the first display device 11 is displayed with a lower brightness than that of the second object 22 displayed on the second display device 12.

Furthermore, the first object 21 and the second object 22 are displayed on different fields or frames by considering the residual image effect of the observer 10. Therefore, in order to reduce the visual unnaturalness, the brightness synthesized from the brightness of the first display device 11 and the brightness of the second display device 12 in displaying the first object 21 is adjusted so as to roughly conform to the brightness synthesized from the brightness the first display device 11 and the brightness of the second display devices 12 in displaying the second object 22.

The signal generation part for the first display device 36 forms a signal of the image to be displayed on the first display device 11 based on the signals of the display image part 32, the brightness modulation part 35 and the synchronization signal part 34. The image signals formed here are those that the brightness in displaying the first object 21 is increased and the brightness in displaying the second object 22 is reduced if the first object 21 is at a position closer to the observer 10 than the second object 22, and synchronization signals for displaying are added.

The signal generation part for the second display device 37 forms a signal of the image to be displayed on the second display device 12 based on the signals of the display image part 32, the brightness modulation part 35 and the synchronization signal part 34. The image signals formed here are those that the brightness in displaying, the first object 21 is reduced and the brightness in displaying the second object 22 is increased if the first object 21 is at a position closer to the observer 10 than the second object 22, and synchronization signals for displaying are added.

The driving part for the first display device 38 displays an image on the first display device 11 by converting the image signals outputted from the signal generation part for the first display device 36 into driving waveforms according to the type of the first display device 11, for example, an EL display device, and applying voltage and current for driving to the first display device 11.

The driving part for the second display device 39 displays an image on the second display device 12 by converting the image signals outputted from the signal generation part for the second display device 37 into driving waveforms according to the type of the second display device 12, for example, an EL display device, liquid crystal display device, CRT display device and the like, and applying voltage and current for driving to the second display device 12.

The 3D image may be obtained by displaying the image signals formed by the method explained above on each of the first display device 11 and the second display device 12.

Firstly, the image 111 of the first object 21 synchronizes to the first display device 11 and the image 121 of the first object 21 synchronizes to the second display device 12, and the images are displayed on the position identical to the line of sight of the observer 10 and further the brightness of the image 111 is higher than that of the image 121. In this case, the observer 10 visually perceives that the image 131 seems to be at a position closer to the first display device 11 as shown in FIG. 1.

On the other hand, at the next display cycle, the image 112 of the second object 22 synchronizes to the first display device 11 and the image 122 of the second object 22 synchronizes to the second display device 12, and the images are displayed on the position identical to the line of sight of the observer 10 and further the brightness of the image 122 is higher than that of the image 112. In this case, the observer 10 visually perceives that the image 132 seems to be at a position closer to the second display device 12 as shown in FIG. 2.

The relationship of the first object 21 and the second object 22 is visually perceived in tandem by repeating the images displayed in this way within the residual image time of the observer 10, and then giving the 3D image.

Furthermore, the 3D display device according to the present invention is characterized in that the use of a display device provided with a phosphorescent organic EL device as the display device at the front enables it easy to observe the display image of the display device at the back by transmitting through the display device at the front, and as a result, a clearer 3D image can be obtained than conventionally. Accordingly, the shooting device and 3D display device are not limited to those described above, and their configurations that have the similar performances and functions as those described above can be adopted.

### THE FIRST EMBODIMENT RELATING TO IMAGE DISPLAY MEANS OF 3D DISPLAY DEVICES

The first embodiment is explained with reference to FIG. 5. As shown in FIG. 5, the first display device 11 of the embodiment is configured by the phosphorescent organic EL display device which displays an image by self-luminescence (L1 and L2) and transmits the light L3 from the second display device 12. This device enables for the observer 10 to see the image displayed on the first display device 11 and also the image displayed on the second display device 12 transmitted through the first display device 11, thereby realizing the miniaturization of the 3D display device.

### THE SECOND EMBODIMENT RELATING TO IMAGE DISPLAY MEANS OF 3D DISPLAY DEVICES

The second embodiment is explained similarly with reference to FIG. 5. As shown in FIG. 5, the first display device 11 of the embodiment is configured by the phosphorescent organic EL display device which displays an image by self-luminescence (L1 and L2) and transmits the light L3 from the back surface. The amount of luminescence from the surface of the device is made to be larger than that from the rear surface. This may be accomplished by adopting a configuration in which the luminescent part of the device is made such that the amount of luminescence at the front is larger. Since the luminescence L2 from the rear surface reaches the second display device 12 as the light L4 transmitted through the device, is reflected on the surface of the second display device 12 as the reflecting light L5 and returns to the first display device 11 to adversely affect the image formation, the quality of the 3D image can be improved by reducing the luminescence L2 from the rear surface, that is, reducing the reflecting light L5 on the surface of the second display device 12.

### THE THIRD EMBODIMENT RELATING TO IMAGE DISPLAY MEANS OF 3D DISPLAY DEVICES

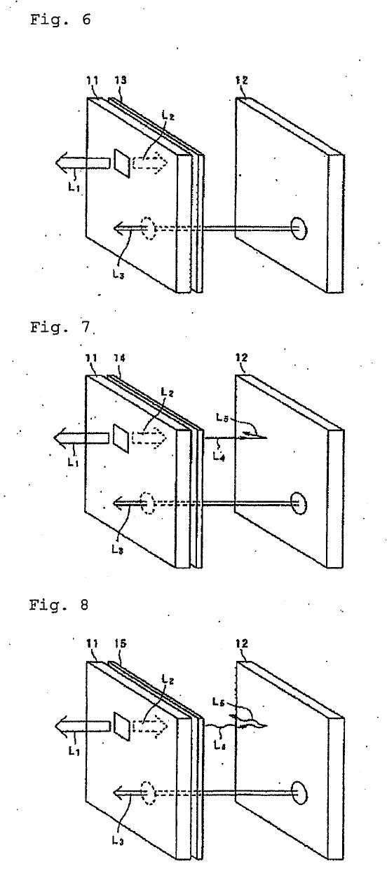

The third embodiment is explained with reference to FIG. 6. As shown in FIG. 6, the first display device 11 of, the embodiment is configured by the phosphorescent organic EL display device which displays an image by self-luminescence (L1 and L2) and transmits the light L3 from the back surface. In addition, a half mirror is disposed on the rear surface of the device. The half mirror blocks the light directing to the second display device 12 from the first display device 11, while the light L3 from the second display device 12 is transmitted through the half mirror 13 and the first display device 11, thereby enabling the observer 10 to see the image displayed on the second display device 12. Since reflection of the light L2 from the back surface of the first display device 11 on the second display device 12 is prevented from returning to the side of the observer 10, it is possible to improve the quality of the 3D image.

### THE FOURTH EMBODIMENT RELATING TO IMAGE DISPLAY MEANS OF 3D DISPLAY DEVICES

The fourth embodiment is explained with reference to FIG. 7. As shown in FIG. 7, the first display device 11 of the embodiment is configured by the phosphorescent organic EL display device which displays an image by self-luminescence (L1 and L2) and transmits the light L3 from the back surface. Further, an optical filer 14 in which the light transmittance to the back is smaller than that to the front is provided on the rear surface of the device. The optical filter 14 reduces the light L4 directing to the second display device 12 from the first display device 11, while the light L3 from the second display device 12 has a smaller attenuation rate in transmitting through the optical filter 14, thereby enabling the observer 10 to see the image displayed on the second display device 12 transmitted through the first display device 11. Since the reflecting light L5 from the second display device 12 is extremely small, it is possible to improve the quality of the 3D image.

### THE FIFTH EMBODIMENT RELATING TO IMAGE DISPLAY MEANS OF 3D DISPLAY DEVICES

The fifth embodiment is explained with reference to FIG. 8. As shown in FIG. 8, the first display device 11 of the embodiment is configured by the phosphorescent organic EL display device which displays an image by self-luminescence (L1 and L2) and transmits the light L3 from the back surface. In addition, a polarizing plate 15 is disposed on the rear surface of the device. The light L4 directing to the second display device 12 from the first display device 11 is polarized by the polarizing plate 15, and the reflecting light L5 reflected on the second display device 12 is blocked to be transmitted through the polarizing plate 15 again so that the reflecting light L5 does not return to the observer 10. On the other hand, the light L3 from the second display device 12 is transmitted through the polarizing plate 15, thereby enabling the observer 10 to see the image displayed on the second display device 12 transmitted through the first display device 11. Since the reflecting light L5 from the second display device 12 does not return to the observer 10, it is possible to improve the quality of the 3D image.

### THE SIXTH EMBODIMENT RELATING TO IMAGE DISPLAY MEANS OF 3D DISPLAY DEVICES

The sixth embodiment is explained with reference to FIG. 9. As shown in FIG. 9, the first display device 11 of the embodiment is configured by the phosphorescent organic EL display device which displays an image by self-luminescence (L1 and L2) and transmits the light L3 from the back surface. An antireflection film 16 is provided on the surface of the second display device 12, and reduces reflection of the light L4 directing to the second display device 12 from the first display device 11. Therefore, only an extremely small amount of the reflected light L5 due to the light L4 is returned to the observer 10. On the other hand, the light L3 from the second display device 12 is transmitted through the antireflection film 16, thereby enabling the observer 10 to see the image displayed on the second display device 12 transmitted through the first display device 11. Since only an extremely small amount of the reflected light L5 from the second display device 12 is returned to the observer 10, it is possible to improve the quality of the 3D image.

Furthermore, in place of providing the antireflection film 16 on the surface of the second display device 12, means for reducing the reflected light L5 may be used which, for example, includes the antireflection treatment to the surface of the second display device 12 by mechanical means or chemical means, or providing a light scattering plate and the like.

The embodiments relating to the first to sixth image display devices are explained hereinbefore, however, it is needless to say that these means may be combined within a technically feasible range. The means includes, for example, reducing the amount of light directing to the back of the display device located at the front, providing an antireflection film on the surface of the display device located at the back and so on.

According to the embodiment as described above, the brightness modulation type 3D display system can be realized by using a relatively simple configuration and control.

In addition, a plurality of object images with a different depth are alternately displayed on two display means located in tandem while controlling the brightness within a period of time in which the residual image effect of an observer is maintained, thereby enabling the observer to see the image while feeling the front-back distance relationship of the plurality of objects.

In the above-mentioned embodiments, examples of 3D display are described, however, a two-dimensional display may be possible by any or a combination of the image display means relating to the first to sixth embodiments.

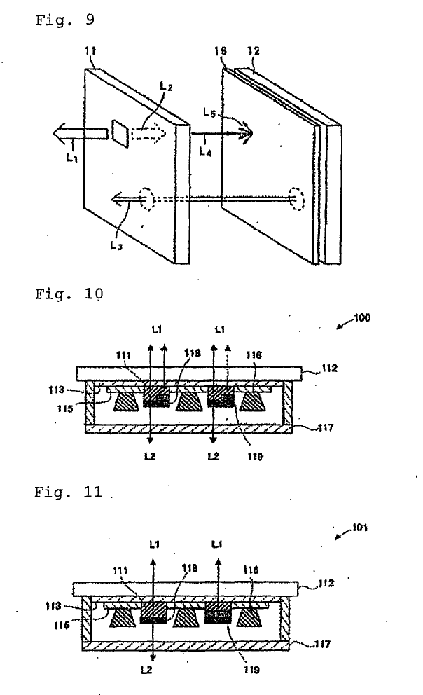

Further, a more detailed example of the first display device 11 having “the structure which increases the amount of luminescence to the front” and the structure which “reduces the luminescence L2 from the rear surface” in the second embodiment is explained with reference to FIG. 10 to FIG. 12. Here, FIG. 10 to FIG. 12 are schematic cross-sectional views showing a concrete structure of the first display device 11 used in the second embodiment.

Concrete examples of the phosphorescent organic EL display device used in the present invention are shown in FIG. 10 to FIG. 12.

The phosphorescent organic EL display device 100 shown in FIG. 10 is configured by an organic EL compound layer 111, a substrate plate 112, an ITO (Indium Tin Oxide) electrode (anode) 113, an insulating film 115, a cathode separator 116, a transparent glass sealing can 117, a transparent electrode 118 and a reflection plate 119.

1. Anode;

The anode 113 is formed by a conductive and light transmitting layer represented by ITO. In addition, an anode used is which is prepared by forming a thin film of 1 nm to 3 nm by depositing a metal such as gold, nickel, manganese, iridium, molybdenum, palladium, platinum and the like on the surface of ITO having excellent light transmittance so as not to damage the light transmittance. A method of preparing a film on the surface of these anode materials includes electronic beam deposition, sputtering method, chemical reaction method, coating method, vacuum deposition method and the like. The thickness of the anode is preferably 2 nm to 300 nm.

2. Element Configuration;

FIG. 13 is a cross-sectional view showing an example of the organic EL element configuration contained in the phosphorescent organic EL display device used in the present invention, in which a hole-transporting layer 111a, a light-emitting layer 111b and an electron-transporting layer 111c are sequentially provided between the anode 113 provided on the transparent substrate 112 and the cathode 119.

Furthermore, the configuration of the phosphorescent organic EL display device used in the present invention is not limited to the example of FIG. 13, but includes the element configuration in which the following layers are sequentially provided; 1) anode buffer layer/hole-transporting layer/light-emitting layer, 2) anode buffer layer/light-emitting layer/electron-transporting layer, 3) anode buffer layer/hole-transporting layer/light-emitting layer/electron-transporting layer, 4) anode buffer layer/layer comprising hole transporting compound, light-emitting compound and electron transporting compound, 5) anode buffer layer/layer comprising hole transporting compound and light-emitting compound, 6) anode buffer layer/layer comprising light-emitting compound and electron transporting compound, 7) anode buffer layer/layer comprising hole electron transporting compound and light-emitting compound, and 8) anode buffer layer/light-emitting layer/hole blocking layer/electron-transporting layer and the like. In addition, the light-emitting layer shown in FIG. 13 is one layer but may be two or more layers. Moreover, a layer containing the hole transporting compound may directly come into contact with the surface of the anode without using the anode buffer layer.

Moreover, in this specification, unless otherwise specified, a compound comprising all or one or more electron transporting compounds, hole transporting compounds and light-emitting compounds shall be referred to an organic EL compound and the layer thereof as an organic EL compound layer.

3. Anode Surface Treatment;

Furthermore, the performance of the overcoat layer (adhesiveness to the anode substrate, surface smoothness, reduction of hole injection barrier, etc.) may be improved by pretreating the anode surface at the time of forming the film of the anode buffer layer or a layer containing the hole transporting compound. The pretreatment methods include high frequency plasma treatment, sputtering treatment, corona treatment, UV ozone irradiation treatment, oxygen plasma treatment and the like.

4. Anode Buffer Layer; In Case of using Baytron etc.;

When the a node buffer layer is manufactured by coating using a wet process, film forming is performed by methods such as spin coat method, casting method, micro gravure coating method, gravure coating method, bar coating method, roll coating method, wire bar coating method, dip coating method, spray coating method, screen printing method, flexo printing method, offset printing method, inkjet printing method and the like.

A compound which may be used in the film forming by the above-mentioned wet process is not especially limited if the compound has good adhesiveness with the anode surface and the organic EL compound contained in the upper layer, however, anode buffers which have generally been used in the past are more preferably applied. The compound includes a conductive polymer, for example, PEDOT-PSS which is a mixture of poly(3,4)-ethylenedioxythiophene and a polystyrene sulfonate, PANI which is a mixture of polyaniline and a polystyrene sulfonate and the like. Moreover, an organic solvent such as toluene, isopropyl alcohol and the like may be added to these conductive polymers. In addition, the conductive polymer containing a third ingredient like a surfactant may be used. As the surfactant, there may be used a surfactant containing one kind of group selected from the group consisting of, for example, alkyl group, alkylaryl group, fluoroalkyl group, alkylsiloxane group, sulfate, sulfonate, carboxylate, amide, betaine structure and quaternary ammonium group, however, a fluoride-based nonionic surfactant may also be used.

5. Organic EL Compound;

As a compound used for the organic EL compound layer 111, that is, the light-emitting layer 111b, the hole-transporting layer 111a and the electron-transporting layer 111c in the phosphorescent organic EL display device used in the present invention, either a low-molecular compound or a high-molecular compound may be used.

In the present invention, a phosphorescent compound is used as the organic EL compound that forms the light-emitting layer. Since the phosphorescent compound has higher degree of transparency than a fluorescent compound (light transmittance is high) after forming a film at the same luminescent color, the transparency of the device for displaying used in the present invention is high. Therefore, the luminescent image from the display means at the back may be observed through the display means comprising the phosphorescent organic EL display device without reducing the lightness (brightness) excessively.

Moreover, the phosphorescent compound is preferably used on account also of high luminous efficiency. The phosphorescent compound with high luminous efficiency is used in the present invention, thereby improving the sharpness of the image more significantly, compared to the case where the fluorescent compound is used with the same electric power consumption.

The phosphorescent compound is exemplified by a low-molecular phosphorescent compound and a high-molecular phosphorescent compound and the like described in Applied Physics, Vol. 70, No. 12, pp 1419-1425 (2001) by Yutaka Ohmori. Among them, the high-molecular phosphorescent compound is preferably used in that the element manufacturing process is simplified.

The organic EL compound layer in the phosphorescent organic EL display device used in the present invention preferably comprises at least one phosphorescent compound, which has a phosphorescent unit that emits phosphorescence and a carrier transporting unit that transports a carrier in one molecule. The high-molecular phosphorescent compound is obtained by copolymerizing a phosphorescent compound having a polymerizable substituent with a carrier transporting compound having a polymerizable substituent. The phosphorescent compound is a metal complex comprising a metal element selected from iridium, platinum and gold, among which an iridium complex is preferable.

The phosphorescent compound with the polymerizable substituent includes, for example, a compound in which one or more hydrogen atoms of metal complexes shown in the following formulas (E-1) to (E-42) are replaced by the polymerizable substituents.

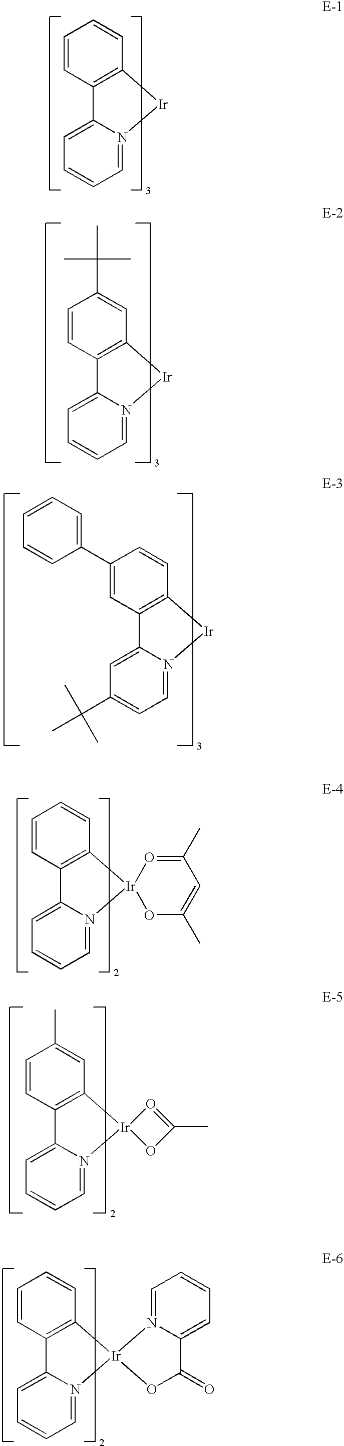

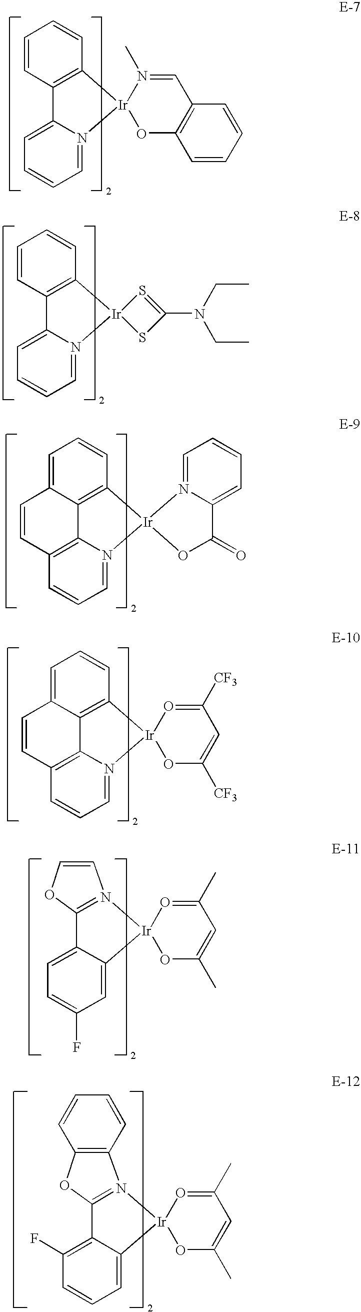

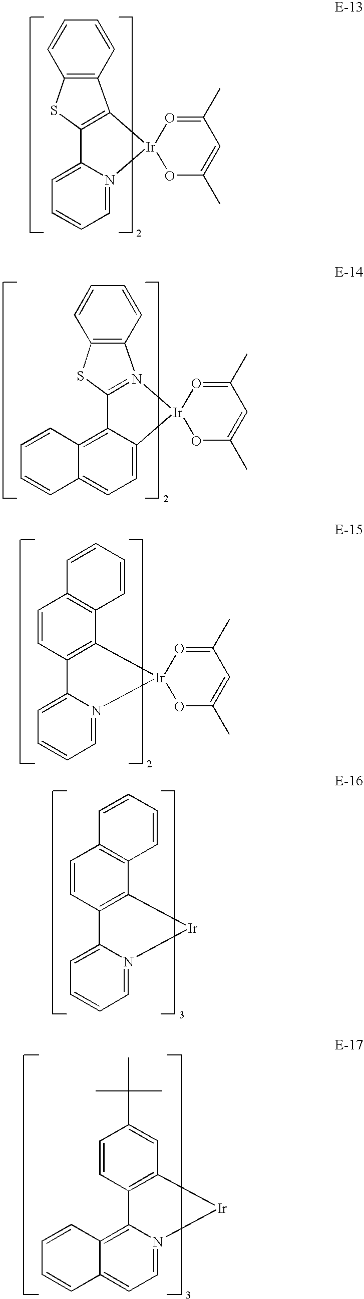

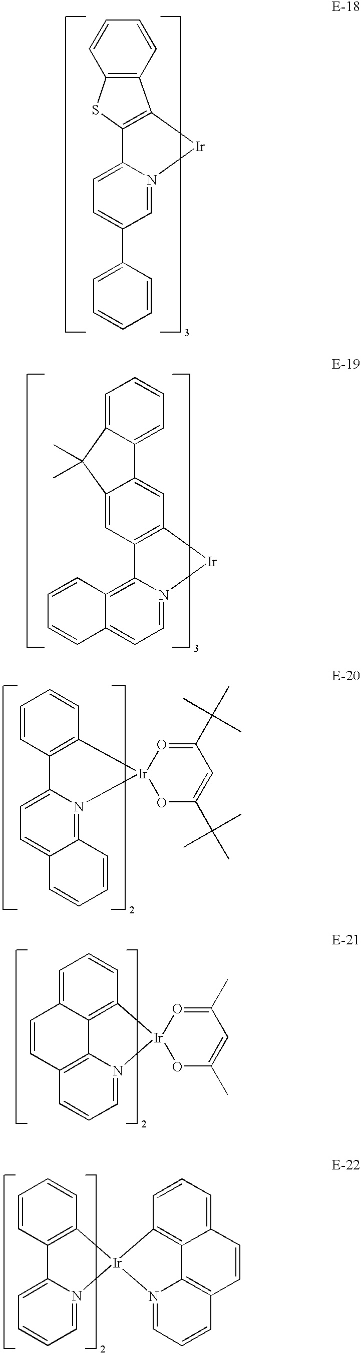

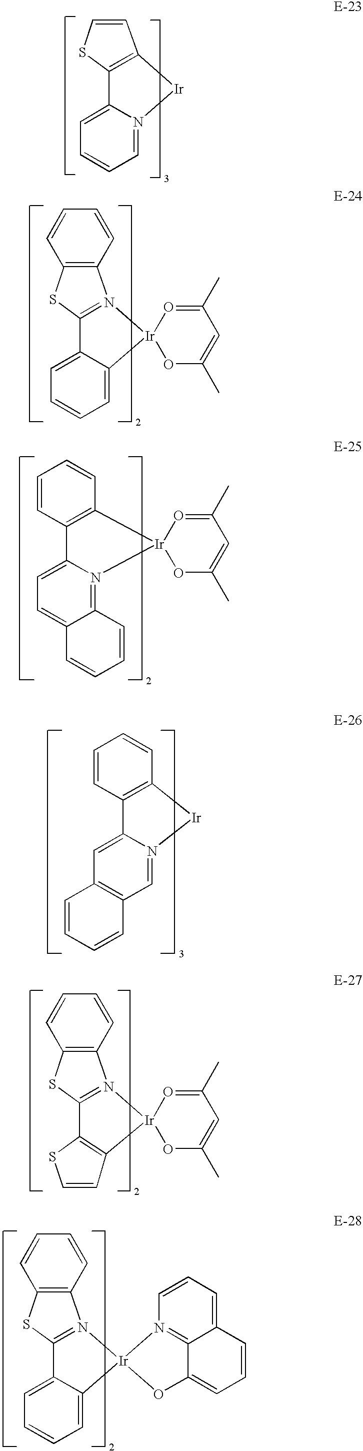

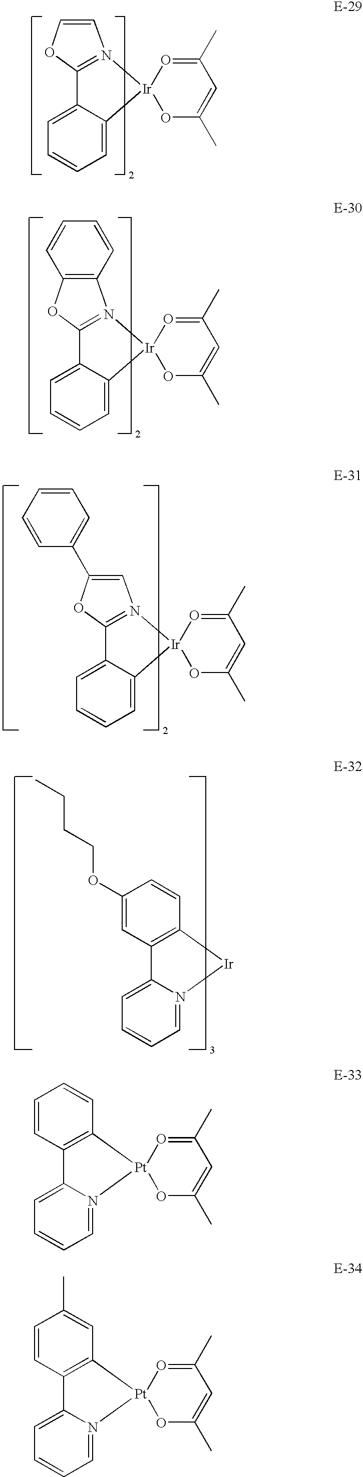

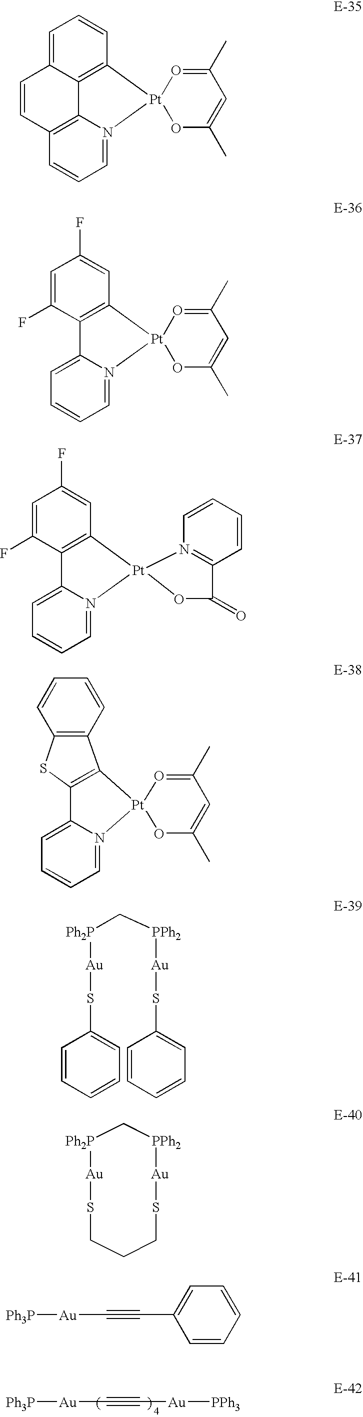

The polymerizable substituent in these phosphorescent compounds includes, for example, vinyl group, acrylate group, methacrylate group, urethane (meth)acrylate group such as methacryloyloxyethylcarbamate group and the like, styryl group and derivative thereof, vinyl amide group and derivative thereof and the like, among which vinyl group, methacrylate group and styryl group and derivative thereof are preferable. These substituents may be bonded to the metal complex through an organic group having 1 to 20 carbon atoms which optionally have hetero atom(s).

The carrier transporting compound having the polymerizable substituent includes a compound in which one or more hydrogen atoms in the organic compounds having either one or both of the hole transporting property and electron transporting property are replaced by the polymerizable substituent. The representative examples of these compounds include the compounds shown by the following formula (E-43) to (E-60).

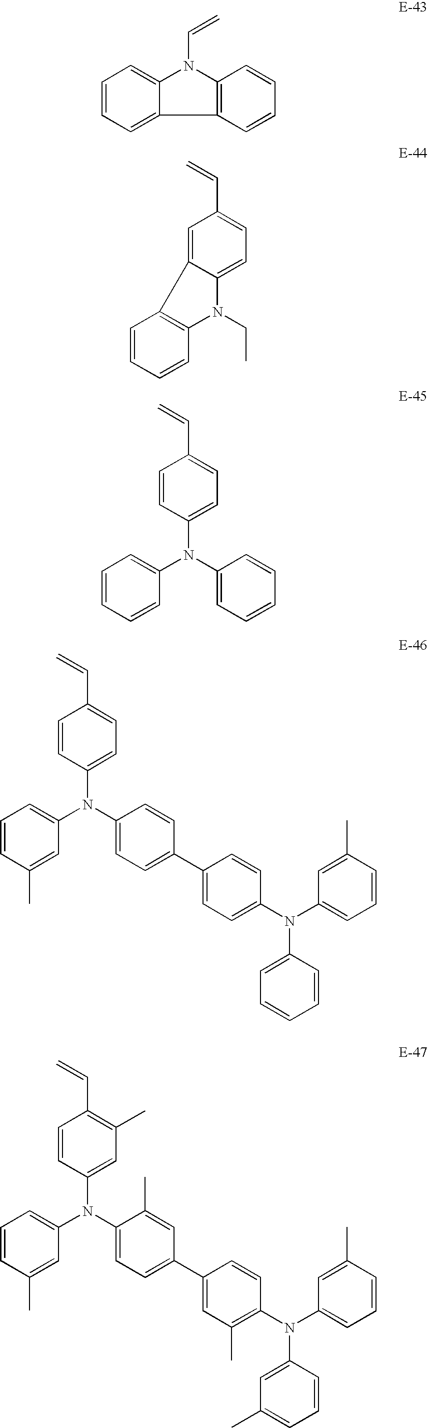

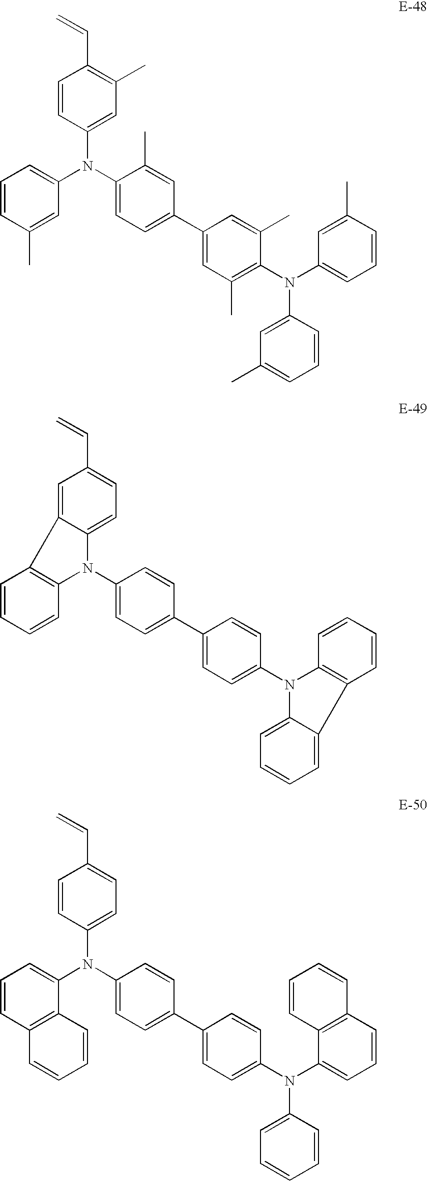

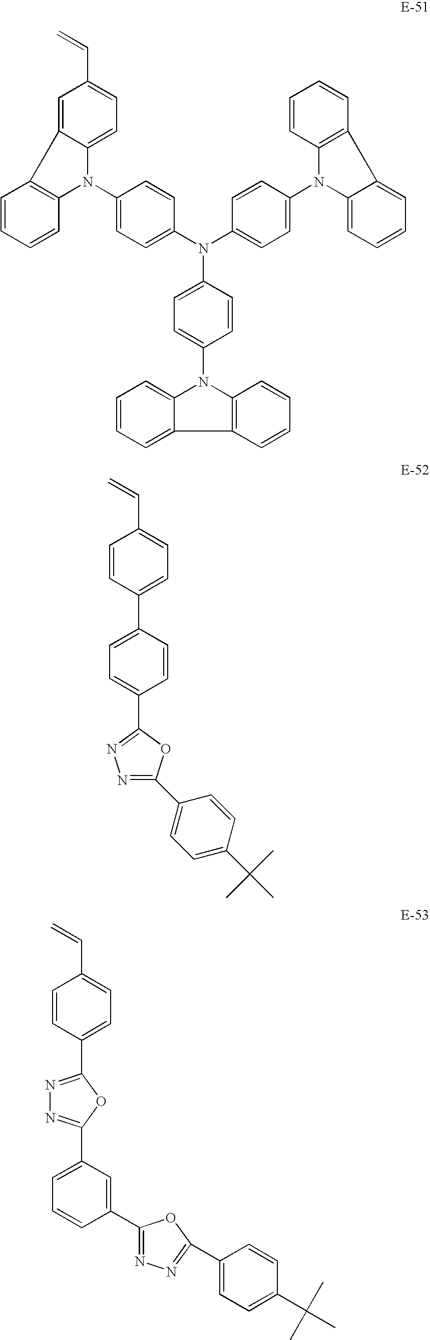

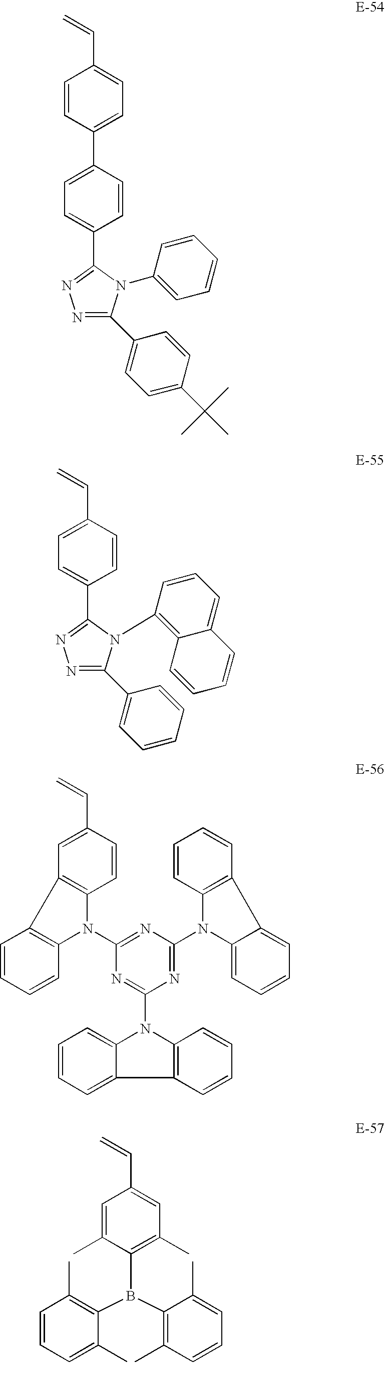

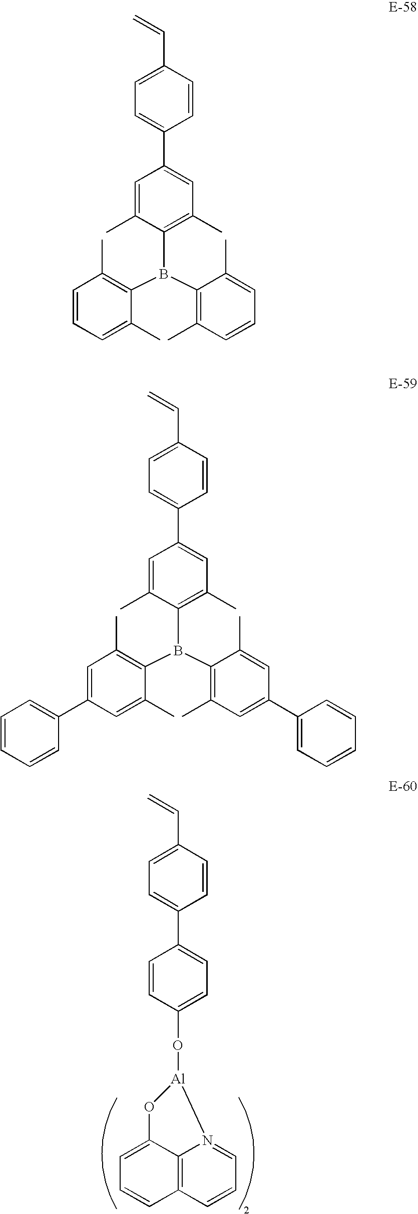

Furthermore, Ph represents a phenyl group in the above formula (E-39) to (E-42). The polymerizable group in these carrier transporting compounds exemplified is vinyl group, however, the vinyl group may be replaced by the polymerizable groups including acrylate group, methacrylate group, urethane (meth)acrylate group such as methacryloyloxyethylcarbamate group and the like, styryl group, and derivative thereof, vinyl amide group and derivative thereof and the like. Moreover, these polymerizable substituents may be bonded to the metal complex through an organic group having 1 to 20 carbon atoms which optionally have hetero atom(s).

The polymerization method of the phosphorescent compound having polymerizable groups and the carrier transporting compounds having polymerizable groups may be carried out by radical polymerization, cationic polymerization, anionic polymerization and addition polymerization, among which, radical polymerization is preferable. The molecular weight of the polymer expressed by weight average molecular weight is preferably 1,000 to 2,000,000, more preferably 5,000 to 1,000,000, wherein the molecular weight is a polystyrene-equivalent molecular weight measured by GPC (gel permeation chromatography).

The phosphorescent polymers described above may be those in which one phosphorescent compound and one carrier transporting compound are copolymerized, one phosphorescent compound and two or more carrier transporting compounds are copolymerized, or two or more phosphorescent compounds are copolymerized with a carrier transporting compound.

The arrangement of monomer units in the phosphorescent high-molecular compound may be any of random copolymers, block copolymers and alternate copolymers. When the repeat unit number of the phosphorescent compound structure is represented by m and the repeat unit number of carrier transporting compound structure by n (m and n are integer of one or more), the ratio of the repeat unit number of the phosphorescent compound structure to the total repeat unit number, that is, the value of m/(m+n) is preferably 0.001 to 0.5, and more preferably 0.001 to 0.2.

More concrete examples and synthetic methods of the phosphorescent high-molecular compound are disclosed in JP-A-2003-342325, JP-A-2003-119179, JP-A-2003-113246, JP-A-2003-206320, JP-A-2003-147021, JP-A-2003-171391, JP-A-2004-346312 and JP-A-2005-97589.

The light-emitting layer in the phosphorescent organic EL display device used in the present invention is preferably a layer containing the phosphorescent compound described above, which may contain a hole transporting compound and an electron transporting compound for the purpose of supplementing the carrier transporting property of the light-emitting layer. The hole transporting compound used for this purpose includes, for example, a low-molecular triphenylamine derivatives such as TPD (N,N′-dimethyl-N,N′-(3-methylphenyl)-1,1′-biphenyl-4,4′-diamine), α-NPD (4,4′-bis[N-(1-naphthyl)-N-phenylamino]biphenyl), m-MTDATA (4,4′,4″-tris(3-methylphenylphenylamino)triphenylamine) and the like, polyvinylcarbazole a compound polymerized by introducing polymerizing functional group(s) into the triphenylamine derivatives, for example, a high-molecular compound having a triphenylamine skeleton disclosed in JP-A-08-157575, polyparaphenylenevinylene, polydialkylfluorene and the like. Moreover, the electron transporting compound includes, for example, a quinolinol derivative metal complex such as Alq₃ (aluminum trisquinolinolate), a low-molecular material such as oxadiazole derivative, triazole derivative, imidazole derivative, triazine derivative, triarylborane derivative and the like, and a compound polymerized, by introducing polymerizing functional group(s) into the low-molecular electron transporting compound, for example, a known electron transporting compound such as polyPBD disclosed in JP-A-10-1665.

6. A Forming Method of an Organic EL Compound Layer;

The organic EL compound layer mentioned above may be formed by using a coating method including resistance heating deposition method, electron beam deposition method, sputtering method, spin coat method, casting method, micro gravure coating method, gravure coating method, bar coat method, roll coat method, wire bar coat method, dip coat method, spray coat method, screen print method, flexo printing method, offset printing method, ink-jet printing method and the like. In the case of the low-molecular light-emitting compound, there are mainly used resistance heating deposition method, electron beam deposition method and sputtering method. In the case of the high-molecular light-emitting compound, there are mainly used spin coat method, casting method, micro gravure coating method, gravure coating method, bar coat method, roll coat method, wire bar coat method, dip coat method, spray coat method, screen print method, flexo printing method, offset printing method, ink-jet printing method and the like.

7. Hole Block Layer;

Moreover, the hole block layer may be disposed adjacent to the cathode side of the light-emitting layer in order to prevent the hole from passing through the light-emitting layer and to efficiently reconnect with electrons in the light-emitting layer. A compound which has a lower HOMO (Highest Occupied Molecular Orbital) than the light-emitting compound may be used to the hole block layer. The compound is exemplified by triazole derivative, oxadiazole derivative, phenanthroline derivative, aluminum complex and the like.

Furthermore, an exciton block layer may be disposed adjacent to the cathode side of the light-emitting layer in order to prevent inactivation of excitons by the cathode metal. A compound which has a larger triplet excitation energy than the light-emitting compound may be used to the exciton block layer. The compound is exemplified by triazole derivative, phenanthroline derivative, aluminum complex and the like.

8. Cathode;

The transparent electrode 118 is, for example, a cathode electrode with light transmittance comprising ITO. In addition, the transparent electrode 118 may be an electrode comprising IZO or a thin-film metal electrode.

As a cathode material for the phosphorescent organic EL device used in the present invention, a material which has a low work-function and is chemically stable is used. A known cathode material is exemplified by Al, MgAg alloy and an alloy of aluminum and alkali metal such as AlLi, ALCa and the like, however, the work function is preferably 2.9 eV or more considering the chemical stability of the material. A film forming method of the cathode material may include resistance heating deposition method, electron beam deposition method, sputtering method, ion plating method and the like. The thickness of the cathode is preferably in a range not to damage the transparency, preferably 2 nm to 500 nm, more preferably 2 nm to 100 nm.

Furthermore, a metal layer which has a lower work function than the cathode may be inserted between the cathode and the organic layer adjacent to the cathode as a cathode buffer layer in order to increase the electron injection efficiency by lowering the electron injection barrier from the cathode to the organic layer. A metal having a low work function which may be used for such purposes includes an alkali metal (Na, K, Tb, Cs), an alkaline earth metal (Sr, Ba, Ca, Mg), a rare earth metal (Pr, Sm, Eu, Yb) and the like. The deposition method and sputtering method may be used as a film forming method of the cathode buffer layer. The thickness of the cathode buffer layer is preferably 0.05 nm to 50 mm, more preferably is 0.1 nm to 20 nm, and most preferably 0.5 nm to 10 nm.

Moreover, the cathode buffer layer may be formed as a mixture of the materials having a low work function described above and an electron transporting compound. In addition, the organic compound described above used for the electron-transporting layer may be used as the electron transporting compound used here. A codeposition method may be used as a film forming method in this case. Furthermore, when a film forming method by coating a solution is possible, a known film forming method may be used which includes spin coating method, dip coating method, ink-jet method, print method, spray method, dispenser method and the like. The thickness of the cathode buffer layer in this case is preferably 0.1 nm to 100 nm, more preferably 0.5 nm to 50 nm, and most preferably 1 nm to 20 nm. A layer comprising a conductive polymer or a layer comprising metal oxides, metal fluorides, organic insulating materials and the like which has an average film thickness of 2 nm or less may be disposed between the cathode and the organic layer.

9. Sealing;

After manufacturing the cathode, a protective layer may be applied which protects the phosphorescent organic EL display device. In order to use stably the phosphorescent organic EL display device for a long period of time, the protective layer and/or a protective cover is preferably applied to protect the phosphorescent organic EL display device from the outside. As the protective layer, a high-molecular compound, a metal oxide, a metal fluoride, a metal boride and the like may be used. In addition, as the protective cover, there may be used a glass plate, a plastic plate on which surface a processing for low water penetration rate is applied, a metal and the like. A sealing method may be suitably used, by which the cover is adhered with the element substrate using a thermosetting resin or a photo-curable resin. By maintaining a space using a spacer, it is easy to prevent the element from being damaged. By sealing an inert gas such as nitrogen and argon in the space, it is possible to prevent the cathode from being oxidized. Furthermore, by placing a desiccant agent such as barium oxide and the like in the space, it is possible to easily prevent the element from being damaged by the water adsorbed in the manufacturing process. Either one or more of the above-mentioned measures are preferably taken.

The transparent glass sealing can 117 protects the above-mentioned configuration elements from the outside influence. Alternatively, a transparent sealing film may be used in addition to or in place of the transparent glass sealing can.

10. Substrate Types;

The substrate 112 protects and supports the organic EL light-emitting layer 111. As the substrate of the phosphorescent organic EL display device, there may be used an insulating substrate transparent to the emission wavelength of the light-emitting compound, for example, a known material such as glass, transparent plastics including PET (polyethylenephthalate) and polycarbonate, silicon substrates and the like. The observer 10 will visually perceive the image formed by the luminescence of the organic EL light-emitting layer 111 through the substrate 112.

The insulation film 115 prevents, current leakage and is formed by, for example, polyimide on the substrate at a part except for the position in which the organic EL light-emitting layer 111 is formed.

The cathode barrier 116 is formed on the insulation film 115 at a part except for the part in which the cathode is formed in order to pattern it to arbitrary shapes at the time of forming the cathode (that is, the transparent electrode 118).

The reflection plate 119 is formed comprising a metal having a high reflection rate such as aluminum and the like. Here, the reflection plate 119 is preferably placed at least a part of the boundary surface between the organic EL light-emitting layer 111 and the transparent electrode 118.

The light emitted from the whole organic EL light-emitting layer 111 is radiated to the front surface by the phosphorescent organic EL display device 100 having such a structure. On the other hand, the light emitted only from the part in which the reflection plate 119 is not provided on the boundary surface with the transparent electrode 118 in the organic EL light-emitting layer 111 is radiated to the rear surface. Therefore, as in the case of the first display device 11 in the above-mentioned second embodiment, the above configuration makes it possible to realize a structure in which the amount of luminescence to the front is increased while the luminescence L2 from the rear surface is decreased.

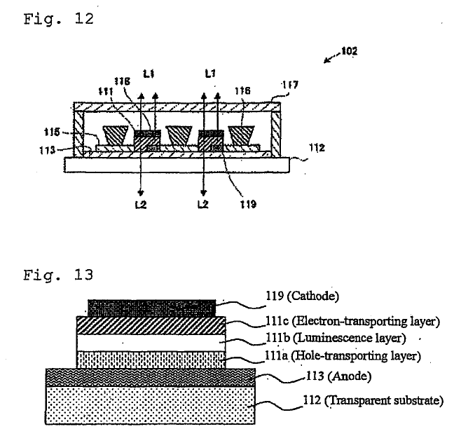

In addition, as shown in FIG. 11, even the phosphorescent organic EL display device 101 having a structure which is provided or not provided with the reflection plate 119 at every organic EL light-emitting layer 111 makes it possible to obtain the similar effect as with the above-mentioned organic EL display device 100.

That is, to the front surface, the light emitted from both the organic EL light-emitting layer 111 not provided with the reflection plate 119 and the organic EL light-emitting layer 111 provided with the reflection plate 119 is radiated. On the other hand, to the rear surface, the light emitted only from the organic EL light-emitting layer 111 not provided with the reflection plate 119 is radiated.

Accordingly, as in the case of the structure shown in FIG. 10, the above configuration makes it possible to realize a structure in which the amount of luminescence to the front surface is increased while the amount of luminescence from the rear surface is decreased.

Moreover, the above-mentioned phosphorescent organic EL display devices 100 and 101 are configured in such a way that the light radiated to the side of the substrate 112 is the luminescence L1 in FIG. 5 and the light radiated to the opposite side of the substrate 112 is the luminescence L2 in FIG. 5. However, the configuration is not limited to the above-mentioned construction, and they may be configured so that the light radiated to the side of the substrate 112 is the luminescence L2 in FIG. 5 and the light radiated to the opposite side of the substrate 112 is the luminescence L1 in FIG. 5. As the phosphorescent organic EL display device 102 in this case, a configuration is preferably adopted in which the reflection plate 119 is provided at the boundary surface between the organic EL light-emitting layer 111 and the ITO electrode 113 or at least one part of the boundary surface, as shown in FIG. 12.

[Applications]

In order to produce the planar luminescence using the phosphorescent organic EL display device used in the present invention, a planar anode and cathode may be disposed so that they are superposed. Moreover, a method for producing a patterned luminescence includes a method of disposing a mask provided with a patterned window on the surface of the planar phosphorescent organic EL display device described above, a method of forming an organic substance layer of the non-luminescent part extremely thick so as to make it substantially non-luminescent, and a method of forming either anode or cathode, or both electrodes in a patterned form. A pattern is formed by any of these methods and a few electrodes are provided so that they may be independently turned on and off, thereby making it possible to obtain a segment-type display element which can display a figure, a character, a simple symbol and the like. Furthermore, in order to obtain a dot matrix element, both the anode and cathode are formed in striped form and arranged orthogonal to each other. A partial color display and multi-color display may become possible by a method of segmenting a plurality of organic EL compounds with a different emission color and a method using a color filter or a fluorescence conversion filter. The dot matrix element may be passively driven or actively driven in combination with TFT and the like.

The 3D display device of the present invention using these phosphorescent organic EL display devices may be used as a display device such as for a computer, household or business television, display of a portable terminal, a cellular phone and a car navigation system or a view finder of a video camera.

Furthermore, the 3D display device of the present invention may be used for an illumination device, interiors and exteriors.

1. A 3D display device, comprising:
a plurality of display means located in tandem on the same line of sight of an observer at a given distance;
a control means which controls the plurality of display means to display an image obtained from the same object on almost the same screen position in each of the plurality of display means by mutually changing the brightness so that a 3D image may be displayed from the sight of the observer;
wherein all the display means or at least one display means except for the display means located at the backmost position from the sight of the observer comprise a device for displaying having an image displaying surface which is self-luminescent and has light transmittance, and
the device for displaying comprises an organic electro-luminescence element provided with an organic electro-luminescence layer containing a phosphorescent compound.

2. The 3D display device according to claim 1, wherein the control means controls
the plurality of display means so that a display means located at the front among the plurality of display means displays the object image at a higher brightness than does a display means located at the back when an object displayed as the object image is displayed so that the object is positioned closer to the sight of the observer, and,
the plurality of display means so that a display means located at the back among the plurality of display means displays the object image at a higher brightness than does a display means located at the front when the object is displayed so that the object is positioned farther away from the sight of the observer.

3. The 3D display device according to claim 2, wherein the control means further controls the plurality of display means so that the brightness synthesized from the display means at the front and the display means at the back may be a given value.

4. The 3D display device according to claim 2, wherein the control means controls the brightness based on the distance from a shooting means when the object is shot to the object.

5. The 3D display device according to claim 2, wherein an input means is further provided which can set the brightness to a desired value.

6. The 3D display device according to claim 1, wherein a display means comprising the device for displaying which emits self-luminescence so that the amount of emission toward the observer is larger than that away from the observer.

7. The 3D display device according to claim 1, wherein a half mirror is further provided on the rear surface of a display means comprising the device for displaying.

8. The 3D display device according to claim 1, wherein a filter in which the amount of transmitted light in the direction away from the observer is smaller than that in the direction toward the observer is further provided on the rear surface of the display means comprising the device for displaying.

9. The 3D display device according to claim 1, wherein a polarizing plate is further provided on the rear surface of the display means comprising the device for displaying.

10. The 3D display device according to claim 1, wherein an antireflection treatment is applied to the surface of the display means located at the back among the plurality of display means.

11. The 3D display device according to claim 1, wherein an antireflection film is provided on the surface of the display means located at the back among the plurality of display means.

12. The 3D display device according to claim 1, wherein a light scattering plate is provided on the surface of the display means located at the back among the plurality of display means.

13. The 3D display device according to claim 1, wherein, unlike the device for displaying, the backmost display means comprises other device for displaying having an image display surface without light transmittance.

14. The 3D display device according to claim 1, wherein the phosphorescent compound is a phosphorescent high-molecular compound.

15. A 3D display method using a 3D display device comprised of a plurality of display means located in tandem on the same line of sight of the observer at a given distance, wherein all the display means or at least one display means except for the display means located at the backmost position from the sight of the observer comprise a device for displaying which has an image display surface that is self-luminescent and has light transmittance, comprising;
a control step of controlling the plurality of display means to display an image obtained from the same object on almost the same screen position in each of the plurality of display means by changing the brightness so that a 3D image may be displayed from the sight of the observer;
wherein the device for displaying comprises an organic electro-luminescence element provided with an organic electro-luminescence layer containing a phosphorescent compound.

16. The 3D display method according to claim 15, wherein the control step comprises:
a step of controlling the plurality of display means so that a display means located at the front among the plurality of display means displays the object image at a higher brightness than does a display means located at the back when an object displayed as the object image is displayed so that the object may be positioned closer to the sight of the observer, and
a step of controlling the plurality of display means so that a display means located at the back among the plurality of display means displays the object image at a higher brightness than does a display means located at the front when the object is displayed so that the object may be positioned farther away from the sight of the observer.

17. The 3D display method according to claim 16, wherein the control step further comprises a step of controlling the plurality of display means so that the brightness synthesized from the display means at the front and the display means at the back may be a given value.

18. The 3D display method according to claim 15, wherein the control step comprises a step of controlling the brightness based on the distance from a shooting means when the object is shot to the object.

19. The 3D display method according to claim 15, wherein the phosphorescent compound is a phosphorescent high-molecular compound.

20. A display device equipped with the 3D display device according to claim 1.

21. A display device according to claim 20, wherein the display device is a display for computer, a display for television, a display for a portable terminal device, a display for a cellular phone, a car navigation display or a view finder of video camera.

22. An illumination device equipped with the 3D display device according to claim 1.

23. An interior equipped with the 3D display device according to claim 1.

24. An exterior equipped with the 3D display device according to claim 1.
